(19) United States
(12) Patent Application Publication
(10) Pub. No.: US 2025/0148769 A1
(43) Pub. Date: May 8, 2025

(54) EFFICIENT EXECUTION OF MACHINE LEARNING MODELS USING PARTITIONING

(71) Applicant: QUALCOMM Incorporated, San Diego, CA (US)

(72) Inventors: Alexander BEYKUN, Newmarket (CA); Sahil GUPTA, San Diego, CA (US); Jian WANG, Thornhill (CA); Prathamesh Prakash PRABHUDESAI, Toronto (CA); Lin WANG, Newmarket (CA); Nathan William LEE, Scarborough (CA); Veluppillai ARULESAN, Concord (CA); Jeffrey Baginsky GEHLHAAR, San Diego, CA (US)

(21) Appl. No.: 18/504,889

(22) Filed: Nov. 8, 2023

(51) Int. Cl. G06V 10/82; G05D 1/08; G06V 20/58

(52) U.S. Cl. CPC G06V 10/82; G06V 20/58

(57) ABSTRACT

Certain aspects provide techniques and apparatuses for efficient operation of a machine learning model based on partitioning the machine learning model. An example method generally includes receiving a graph for a machine learning model. The graph for the machine learning model generally includes a plurality of subgraphs representing different portions of the machine learning model. The machine learning model is instantiated across a plurality of process domains associated with a same application based on the plurality of subgraphs in the graph for the machine learning model. An inference is generated based on executing the machine learning model across the plurality of process domains, and one or more actions are taken based on the generated inference.

### INTRODUCTION

Aspects of the present disclosure relate to machine learning models, and more specifically to efficient execution of machine learning models based on partitioning machine learning models.

Machine learning models, such as convolutional neural networks, transformer neural networks, and the like, are used for various tasks, such as object detection in visual content, segmentation of visual content, processing data having objects with different dimensions, generating natural language responses to natural language queries, and the like. In order to perform these tasks, these machine learning models may be trained to perform various operations internally (e.g., to map input data into representations in a latent space based on which an inference can be performed, to project inputs into tokens (e.g., key, query, and value tokens in a transformer neural network), apply an activation function to data generated by the machine learning model, etc.). These operations may vary in complexity, from relatively simple mathematical operations (e.g., addition, multiplication, etc.) to complex mathematical operations that involve significant amounts of processor time and memory utilization.

Machine learning models may be deployed to devices having various processors which can perform operations of varying complexity with varying power utilization and performance characteristics. For example, these devices may include one or more of a central processing unit (CPU), a graphics processing unit (GPU), a tensor processing unit (TPU), a neural processing unit (NPU), or the like, and each of these processing units may include one or more processing cores which can be used to perform different operations using a machine learning model.

### BRIEF SUMMARY

Certain aspects of the present disclosure generally relate to efficient execution of machine learning models based on partitioning machine learning models.

Certain aspects of the present disclosure provide a method that generally includes receiving a graph for a machine learning model. The graph for the machine learning model generally includes a plurality of subgraphs representing different portions of the machine learning model. The machine learning model is instantiated across a plurality of process domains associated with a same application based on the plurality of subgraphs in the graph for the machine learning model. An inference is generated based on executing the machine learning model across the plurality of process domains, and one or more actions are taken based on the generated inference.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict only certain aspects of this disclosure and are therefore not to be considered limiting of the scope of this disclosure.

FIG. 1 illustrates an example graph for a machine learning model including a plurality of subgraphs, according to aspects of the present disclosure.

FIG. 2 is a message flow diagram illustrating an example of messages exchanged to instantiate a machine learning model across a plurality of process domains based on a graph for the machine learning model including a plurality of subgraphs, according to aspects of the present disclosure.

FIG. 3 is a message flow diagram illustrating an example of messages exchanged to generate an inference using a machine learning model executing across a plurality of process domains based on a graph for the machine learning model including a plurality of subgraphs, according to aspects of the present disclosure.

FIG. 4 is a message flow diagram illustrating an example of messages exchanged to terminate execution of a machine learning model across a plurality of process domains, according to aspects of the present disclosure.

FIG. 5 illustrates example operations for efficiently executing a machine learning model instantiated across a plurality of process domains based on partitioning, according to aspects of the present disclosure.

FIG. 6 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatus, methods, processing systems, and computer-readable mediums for efficiently executing a machine learning model across multiple process domains based on partitioning the machine learning model.

A computing device on which machine learning models execute generally includes different types of processors. For example, such a computing device may include a central processing unit (CPU), a graphics processing unit (GPU), a neural processing unit (NPU), and/or other processing units which can perform operations on input data and generate an output based on these operations. Each of these processors may support one or more process domains on which applications loaded on the computing device (e.g., software applications that use generative artificial intelligence models to generate responses to input queries, video processing applications that compress and decompress audiovisual content, self-driving applications that control an autonomous vehicle, etc.), or a portion thereof, can be stored in memory and executed. Each process domain may have a maximum addressable memory size (e.g., based on a bit size of memory addresses associated with the process domain) which may be associated with, for example, an amount of on-processor memory. Applications which fit within the maximum addressable memory space of a process domain may thus execute without swapping data into and out of a memory associated with the process domain. However, applications which do not fit within the maximum addressable memory space of a process domain may execute by swapping data into and out of memory. Because operations may not be performed while data used within these operations is swapped into memory, swapping data into and out of memory may introduce latencies and other delays in performing operations within a process domain.

Some machine learning models, such as large language models, generative artificial models that are trained to generate a response to an input query, and other sizable machine learning models, may have large memory overhead. For example, a large language model including billions of tokens may have a memory overhead that greatly exceeds the amount of addressable memory space available within a process domain. In cases in which a machine learning model does not fit within the addressable memory space associated with a process domain, training and inferencing operations may thus involve various memory swap operations which, as discussed above, degrade the performance of these operations. Further, in some cases, the performance of these machine learning models may be negatively impacted by memory thrashing, a phenomenon in which data is repeatedly swapped between on-processor and off-processor memory in order to perform an operation, with each swap incurring a performance penalty.

Aspects of the present disclosure provide techniques for efficiently executing a machine learning model based on a subgraph decomposition of a machine learning model. As discussed in further detail below, a machine learning model, which may be represented by a graph, may be divided into a plurality of subgraphs, with each subgraph having defined inputs, outputs, and relationships with other subgraphs within the graph for the machine learning model. To execute operations using a machine learning model, the machine learning model may be instantiated across a plurality of process domains based on the amount of memory associated with each subgraph and an available amount of memory in the process domain(s) on which the machine learning model may be deployed. Generally, subgraphs may be instantiated on process domains such that the amount of memory associated with a subgraph is less than the total amount of available memory within a process domain on which the subgraph is instantiated, and thus, such that a subgraph does not cross process domains or use more than the total amount of available memory associated with a process domain (and thus subject the subgraph to the overhead of swapping data into and out of memory). By doing so, aspects of the present disclosure may allow for inferencing operations to be performed using large machine learning models in such a manner that minimizes, or at least reduces, the impact of memory swap overhead on the performance of these operations. Further, aspects of the present disclosure may reduce the amount of computational resources (e.g., processing time, memory, network bandwidth, etc.) that are spent in an idle state during inference operations using a machine learning model instantiated across a plurality of process domains, which in turn may increase the availability of computing resources for use by other processes executing in a computing environment.

### Example Machine Learning Model Operations Across Process domains

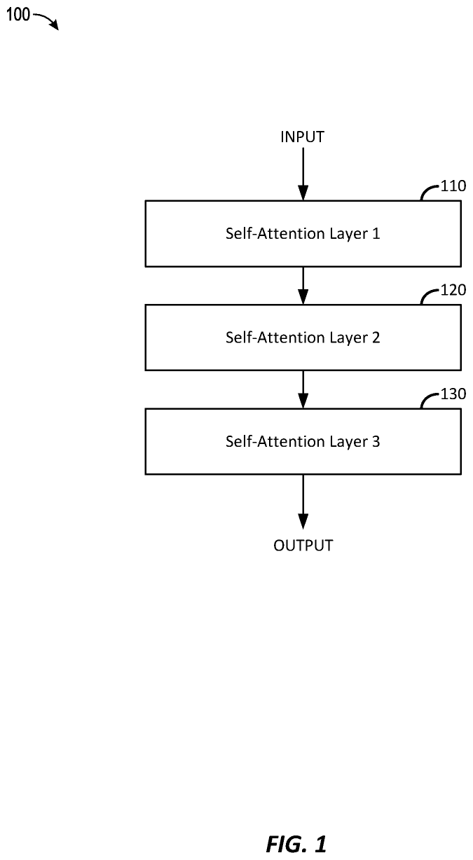

FIG. 1 illustrates an example graph 100 for a machine learning model including a plurality of subgraphs, according to aspects of the present disclosure.

Generally, the graph 100 illustrates a sequence of operations within a machine learning model. These operations can be divided into a plurality of subgraphs for instantiation across a plurality of process domains having defined maximum addressable memory spaces. In this example, the graph 100 illustrates a transformer neural network in which inputs are projected into key data and query data in order to generate a set of values as output. As illustrated, the graph 100 includes a first self-attention layer 110, a second self-attention layer 120, and a third self-attention layer 130. An input (based on which an inference is to be generated) may be received at the first self-attention layer 110, and an output (e.g., an inference, generated response to an input prompt, etc.) may be emitted from the third self-attention layer 130. While the graph 100 illustrates an example of a transformer neural network including a plurality of self-attention layers represented as a graph, it should be recognized that the graph 100 may represent any sort of machine learning model which can be decomposed into a plurality of portions for instantiation and execution across different process domains. These machine learning models may include convolutional neural networks, recurrent neural networks, adversarial networks including models that continually learn from the outputs of other models in the network, and the like.

In the graph 100, outputs of one layer may be mapped to inputs of another layer to allow for a machine learning model to be instantiated across different process domains in a computing system. For example, the input of the first self-attention layer 110 need not be mapped to the output of another self-attention layer in the machine learning model, as the input into the first self-attention layer 110 may be an input prompt or other input based on which an inference is to be generated. The output of the first self-attention layer 110, though, may serve as an input into the second self-attention layer 120. The output of the second self-attention layer 120 may, in turn, serve as an input into the third self-attention layer 130. Finally, the output of the third self-attention layer 130 may serve as the output of the machine learning model represented by the graph 100.

In the example illustrated in FIG. 1, the first self-attention layer 110, the second self-attention layer 120, and the third self-attention layer 130 may have a combined memory overhead that is smaller than the addressable memory space of a process domain on which a machine learning model is executed. Because the first self-attention layer 110, the second self-attention layer 120, and the third self-attention layer 130 may fit within the addressable memory space of a process domain, these self-attention layers 110, 120, and 130 may correspond to subgraphs within the graph 100 for the machine learning model. It should be recognized, however, that in some scenarios, a subgraph may be associated with a portion, and not the entirety, of a layer of a machine learning model.

To support the deployment of a machine learning model across different process domains, the machine learning model may be divided, or partitioned, into a plurality of subgraphs a priori. The partitioning of a machine learning model may be performed based on a defined maximum addressable memory size of a process domain for a device on which the machine learning model is to execute. In some aspects, the division of a machine learning model into a plurality of subgraphs from which the graph 100 may be formed may be performed prior to deployment of a trained machine learning model to a device for use in inferencing operations. In some aspects, the division of the machine learning model into the plurality of subgraphs may be performed dynamically prior to instantiation of the machine learning model across different process domains for use in inferencing operations.

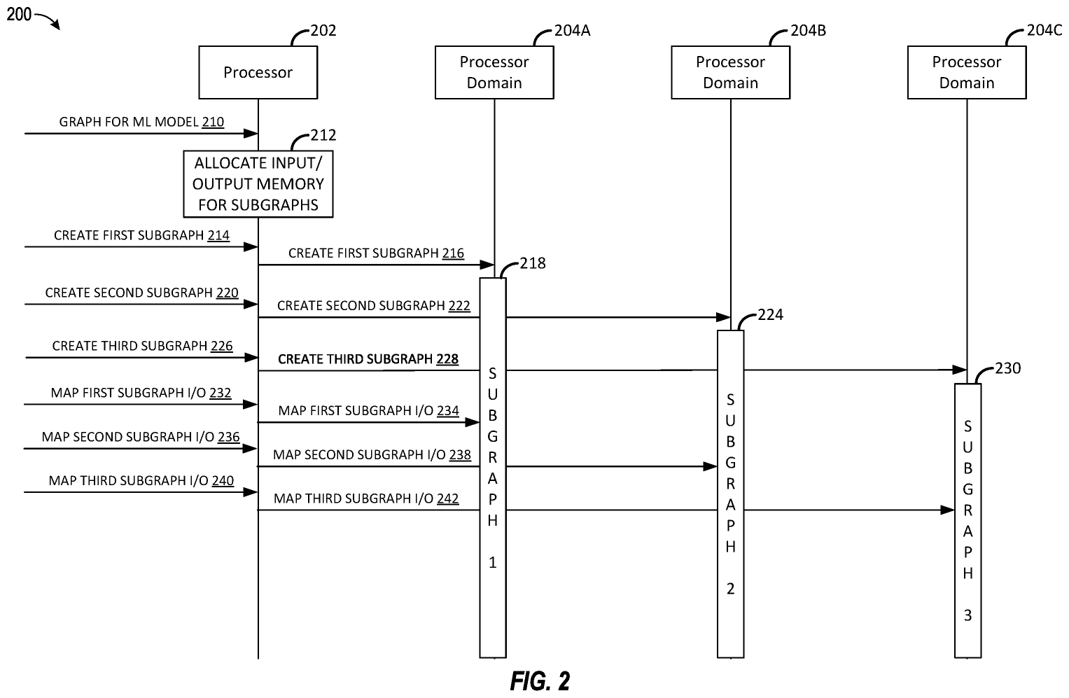

To allow for a machine learning model to be executed efficiently across process domains, the subgraphs in a graph representation of a machine learning model may be instantiated across different process domains by a client application executing on a processor. FIG. 2 is a message flow diagram 200 illustrating an example of messages exchanged to instantiate a machine learning model across a plurality of process domains 204 based on a graph for the machine learning model including a plurality of subgraphs, according to aspects of the present disclosure.

As illustrated, in the message flow diagram 200, a processor 202 may orchestrate the instantiation of one or more process domains 204 for different portions of a machine learning model (e.g., different subgraphs in a graph for a machine learning model, such as the graph 100 illustrated in FIG. 1). While the message flow diagram 200 illustrates the instantiation of subgraphs on three different process domains 204A, 204B, and 204C (collectively referred to herein as “process domains 204”), it should be recognized that a graph for a machine learning model may include any number of subgraphs, and these subgraphs may be instantiated across any number of process domains existing on the same or different hardware (e.g., with one or more process domains being instantiated on a specific processing device, such as a GPU, NPU, special-purpose processor (e.g., application-specific integrated circuit (ASIC), field programmable gate array (FPGA), etc.), or the like). For example (though not illustrated in FIG. 2), in a scenario in which the total memory allocation associated with multiple subgraphs is less than the total addressable memory size associated with a process domain, these multiple subgraphs may be instantiated on the same process domain. However, as discussed above, to minimize, or at least reduce, the impact of memory swapping overhead in performing inferences using a machine learning model, each subgraph may have a total memory overhead that is less than or equal to the total addressable memory space on a process domain so that each subgraph fits within the memory space associated with any given process domain.

To instantiate a machine learning model for use in performing inferencing operations on input data, the processor 202 receives (e.g., from an application executing on a computing device including the processor 202) a message 210 indicative of a graph (e.g., the graph 100 illustrated in FIG. 1) for a machine learning model to be executed across a plurality of process domains. The graph generally includes a plurality of subgraphs, with information identifying inputs into and outputs generated by each subgraph, relationships between each subgraph, and the like. Based on the message 210, the processor allocates input and output memory for the subgraphs at block 212. Generally, in allocating input and output memory for the subgraphs, one or more memory addresses may be allocated for inputs and outputs for each subgraph in the graph indicated by the message 210. These memory addresses may be bound to the subgraphs instantiated across the process domains 204.

After memory is allocated for the inputs into and outputs of the subgraphs representing different portions of the machine learning model to be executed on a computing device, the subgraphs may be instantiated on different process domains. Generally, the application implementing the machine learning model can sequentially create contexts associated with each subgraph on different process domains 204 and bind the memory addresses associated with the inputs into and outputs of the subgraphs to the allocated input and output memory generated at block 212. As illustrated, the processor 202 receives a command 214 to create a first subgraph from the application. The command 214 generally includes information that can be used to determine a process domain on which the first subgraph is to be instantiated, such as an amount of memory associated with the first subgraph, relationship information between the first subgraph and one or more other subgraphs in the graph for the machine learning model, or the like. In response, the processor 202 identifies a process domain (e.g., process domain 204A) on which the first subgraph can be instantiated and creates the first subgraph by instantiating the first subgraph on this identified process domain via a message 216. Generally, the processor 202 can identify the process domain on which the first subgraph can be instantiated based at least in part on the amount of memory associated with the first subgraph and an amount of available memory associated with this process domain. If the amount of memory associated with the first subgraph is less than the amount of available memory associated with a process domain (e.g., the process domain 204A illustrated in FIG. 2), the first subgraph may be instantiated on the process domain. In some aspects, the processor 202 can identify the process domain 204 on which the first subgraph is to be instantiated using a “greedy” algorithm that chooses the first available process domain having a sufficient amount of available memory for instantiating the first subgraph (e.g., the first process domain having an amount of available memory that exceeds the amount of memory associated with the first subgraph). Subsequently, the first subgraph 218 is made available for use in performing inferencing operations.

The processor 202 similarly receives a command 220 to create a second subgraph and a command 226 to create a third subgraph from the application. In response, the processor 202, similarly to the process described above with respect to the first subgraph 218, identifies process domains (e.g., the process domains 204B and 204C) for the second subgraph 224 and the third subgraph 230 and instantiates the second subgraph 224 and the third subgraph 230 on the appropriate process domain 204 via commands 222 and 228, respectively.

After the first subgraph 218, second subgraph 224, and third subgraph 230 have been instantiated on the process domains 204A, 204B, and 204C, respectively, the inputs and outputs associated with the subgraphs 218, 224, and 230 may be mapped to the allocated input and output memory spaces for these subgraphs. The processor 202 may receive a command 232 to map inputs and outputs of the first subgraph 218 to the appropriate spaces in memory and transmit a corresponding command 234 to the first subgraph 218. The input for the first subgraph 218 may be mapped to a space in memory at which inputs are expected to be received, and the output for the first subgraph 218 may be mapped to a space allocated at block 212 for the output of the first subgraph 218.

Similarly, the processor 202 may receive a command 236 to map inputs and outputs of the second subgraph 224 to the appropriate spaces in memory and transmit a corresponding command 238 to the second subgraph 224. Because the second subgraph 224 uses the output of the first subgraph 218 as an input, the input memory space for the second subgraph 224 may be mapped to the same space as the output of the first subgraph 218. The output of the second subgraph 224 may be mapped to a space allocated at block 212 for the output of the second subgraph 224.

Finally, the processor 202 may receive a command 240 to map inputs and outputs of the third subgraph 230 to the appropriate spaces in memory and transmit a corresponding command 242 to the third subgraph 230. Similar to the second subgraph 224, which uses the output of a preceding subgraph as an input, the third subgraph 230 uses the output of the second subgraph 224 as an input. Thus, the input memory space for the third subgraph 230 may be mapped to the output of the second subgraph 224. Meanwhile, the output of the third subgraph 230 may be mapped to a space allocated at block 212 for the output of the third subgraph 230. This space may, as illustrated, correspond to a location in memory at which an inference is to be stored for a given input into the machine learning model for processing. At this point in time, as illustrated, the graph for the machine learning model has been instantiated across a plurality of process domains 204A-204C, all of which may be associated with an underlying application. The device on which the machine learning model operates may now be ready to perform inferences using the machine learning model based on the subgraphs 218, 224, 230 deployed and instantiated across the different process domains 204A-204C.

While FIG. 2 illustrates the instantiation of a single subgraph on each process domain 204A-204C, it should be recognized that any number of subgraphs may be instantiated on a process domain 204.

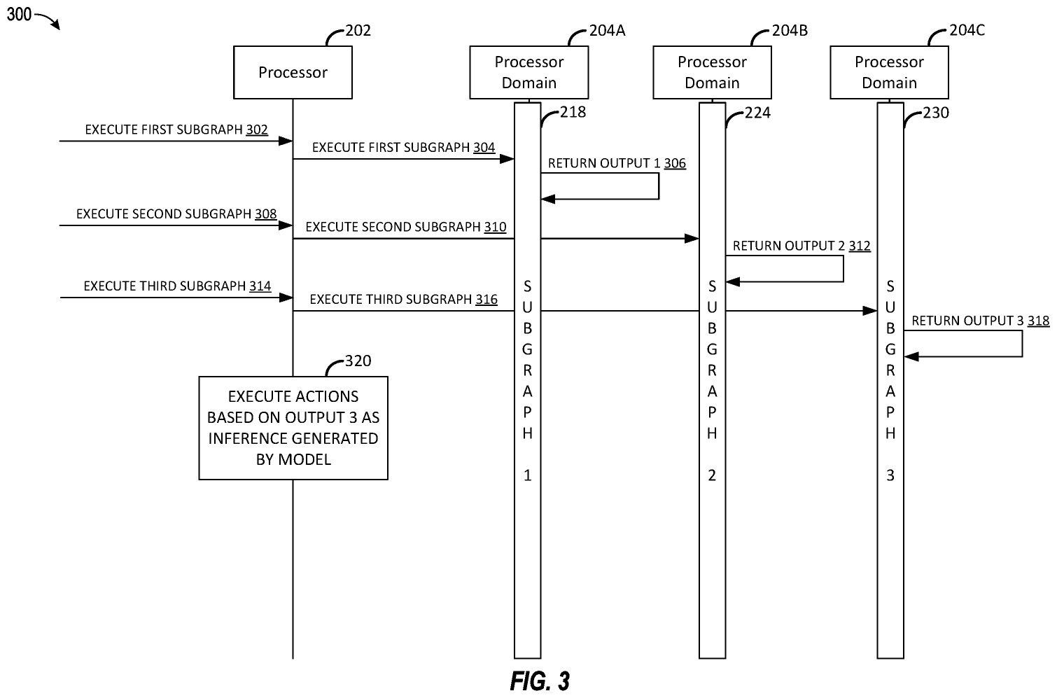

FIG. 3 is a message flow diagram 300 illustrating an example of messages exchanged to generate an inference using a machine learning model executing across a plurality of process domains 204 based on a graph for the machine learning model including a plurality of subgraphs, according to aspects of the present disclosure.

To generate an inference, as illustrated in the message flow diagram 300, operations may be executed across the subgraphs 218, 224, and 230 (and in some cases, others not illustrated in FIG. 3) sequentially based on the relationships between the different subgraphs defined in the graph for the machine learning model. The processor 202 may initially receive a command 302 to execute the first subgraph 218 and forward this command (as a forwarded command 304) to the first subgraph 218 executing on the first process domain 204A. The first process domain 204A can, in response to receiving the forwarded command 304 generate and return a first output 306 in response to the input provided by the processor 202 to the first subgraph 218 executing on the first process domain 204A. Because, as discussed above, the output of the first subgraph 218 is mapped to a memory region allocated for the output of the first subgraph and correspondingly to the input of the second subgraph 224, the first output 306 of the first subgraph 218 may be made available for the second subgraph to use.

Subsequently, as illustrated, the processor 202 can receive a command 308 to execute the second subgraph 224 and forward this command (as forwarded command 310) to the second subgraph 224 executing on the second process domain 204B. The second subgraph 224 can ingest input data from the input memory location to which the second subgraph 224 is mapped (which, as discussed above, includes the memory allocated for the output of the first subgraph 218) and generate and return a second output 312 based on the first output 306. The second output 312, as discussed, is mapped to a memory region allocated for the output of the second subgraph 224 and correspondingly to the input of the third subgraph 230. Similarly, the processor 202 can receive a command 314 to execute the third subgraph 230 and forward this command (as forwarded command 316) to the third graph 230 executing on the third process domain 204C. The third subgraph 230 can ingest input data from the input memory location to which the third subgraph 230 is mapped (which, as discussed above, includes the memory allocated for the output of the second subgraph 224) and generate and return a third output 318 based on the second output 312.

As illustrated, execution of the third subgraph 230 results in the generation of an output of the machine learning model (e.g., an inference, such as a classification, a textual response or response in a non-textual modality generated in response to an input query received by an application for which the machine learning model is deployed, etc.). Based on the output of the machine learning model being an inference generated by the machine learning model, the processor 202 can execute one or more actions. The one or more actions may include generating, modifying (e.g., based on other ground-truth data sources), and outputting a response to an input query. In some aspects, where the machine learning model implemented by the subgraphs 218, 224, 230 generates identifications of different objects within a scene and predicts the distance from a reference plane of these objects, the one or more actions may include generating one or more control signals to control the direction and/or velocity of travel of an autonomous vehicle in order to minimize, or at least reduce, the risk of the autonomous vehicle colliding with an object identified in a scene. In yet another example, in some aspects, the one or more actions may include identifying a level of compression to use in compressing video or other visual content based on a level of importance to different regions captured in a scene, with particular types of objects, such as foreground content or content in motion, being compressed at a higher bit rate (and thus a higher degree of detail preservation) than background content or stationary content. It should be recognized, however, that these are but examples of actions which may be performed based on an inference generated by a machine learning model partitioned and executing across the process domains 204 based on a graph for the machine learning model, and other examples of actions (and other types of inferences) being contemplated herein.

In some aspects, execution of inferencing operations using the machine learning model may be implemented as an atomic operation in which the entirety of the operation is executed without interruption. To execute the inferencing operations as an atomic operation, atomicity may be enforced by an application executing on a client device. Such enforcement may be performed, for example, by disabling interrupts at the processor 202 prior to commanding the first subgraph 218 to generate an intermediate output and by enabling interrupts at the processor 202 after the third subgraph 230 has generated an output for the input. In some aspects, the forwarded command 304 to execute the first subgraph may enforce atomicity of an operation across the process domains 204A-204C based on an identification within the forwarded command 304.

While FIG. 3 illustrates that an output of each subgraph 218, 224, 230 is returned to the subgraph, it should be recognized that the output of any of these subgraphs may also or alternatively be returned to the processor 202 or another processor (not illustrated) of a computing device on which the machine learning model executes.

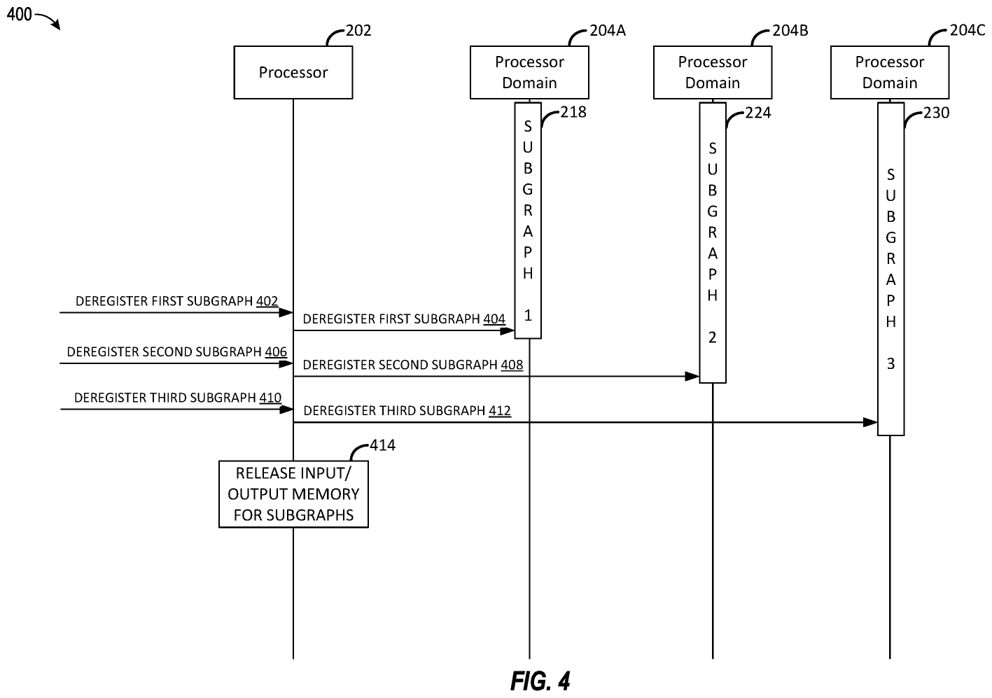

FIG. 4 is a message flow diagram 400 illustrating an example of messages exchanged to terminate execution of a machine learning model across a plurality of process domains 204, according to aspects of the present disclosure.

As illustrated, to terminate execution of a machine learning model, the subgraphs 218, 224, 230 may be deregistered from the respective process domains 204A, 204B, and 204C. A request 402 to deregister the first subgraph 218 may be received at the processor 202 and forwarded (as forwarded request 404) to the process domain 204A associated with the first subgraph 218. After the forwarded request 404 is received by the process domain 204A, execution of the first subgraph 218 may be terminated. Similar operations may be performed with respect to the second subgraph 224 (e.g., based on receiving a request 406 to deregister the second subgraph and forwarding this request (as forwarded request 408) to the second process domain 204B associated with the second subgraph 224) and with respect to the third subgraph 230 (e.g., based on receiving a request 410 to deregister the third subgraph 230 and forwarding this message (as forwarded request 412) to the third process domain 204C associated with the third subgraph).

After the first subgraph 218, second subgraph 224, and third subgraph 230 have been deregistered, the processor 202 may clean up the memory associated with these subgraphs 218, 224, 230 (e.g., the memory allocated by the processor 202 executing block 212 illustrated in FIG. 2). To clean up the memory associated with the subgraphs 218, 224, 230, the processor 202 can generate and execute one or more commands at block 414 to release the memory mapped to each subgraph. After executing the commands at block 414, the device on which the machine learning model executes may be returned to a pre-execution state, with the previously allocated memory and process domains being made available for other operations.

### Example Operations for Executing Machine Learning Model Operations Across Process Domains

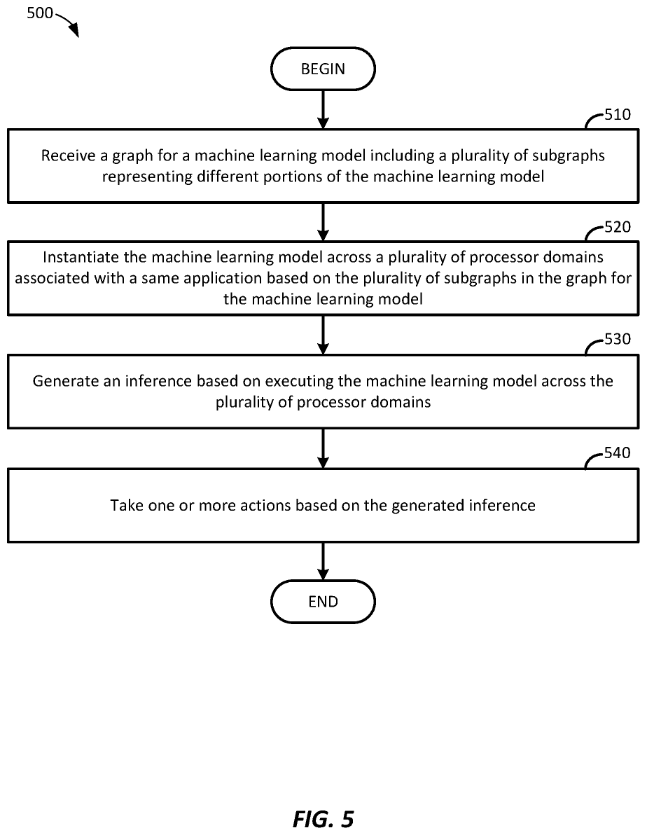

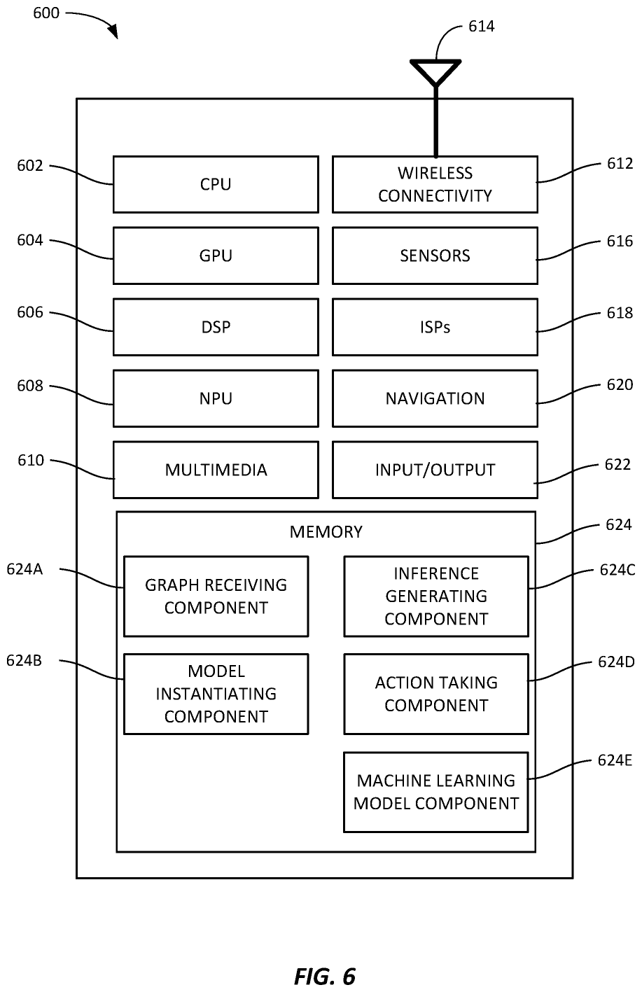

FIG. 5 illustrates example operations for efficiently executing a machine learning model instantiated across a plurality of process domains based on a partitioning of the machine learning model, according to aspects of the present disclosure. The operations 500 may be performed, for example, by a processing system (e.g., the processing system 600 illustrated in FIG. 6) on which a machine learning model is deployed for use in generating inferences on input data. These processing systems may include, for example, smartphones, autonomous vehicles, computing devices communicatively coupled with robots, and so on.

As illustrated, the operations 500 begin at block 510 with receiving a graph (or an indication thereof) for a machine learning model. The graph for the machine learning model generally includes a plurality of subgraphs, and each subgraph may represent a different portion of the machine learning model.

At block 520, the operations 500 proceed with instantiating the machine learning model across a plurality of process domains associated with a same application based on the plurality of subgraphs in the graph for the machine learning model.

In some aspects, instantiating the machine learning model across the plurality of process domains may include instantiating a portion of the machine learning model represented by a corresponding subgraph from the plurality of subgraphs based on an amount of memory associated with the portion of the machine learning model and an available amount of memory on a process domain from the plurality of process domains. Generally, as discussed, a portion of a machine learning model represented by a subgraph may be instantiated on a process domain when the amount of memory associated with the portion of the machine learning model (e.g., a total memory overhead) is less than the total amount of available addressable memory on the process domain. A portion of the machine learning model may not be instantiated on a process domain when the amount of memory associated with the portion of the machine learning model exceeds the total amount of available addressable memory on the process domain, as instantiating the portion of the machine learning model on such a process domain may subject inferencing operations to overhead and latencies caused by swapping data into and out of memory. In some cases, multiple portions of a machine learning model may be instantiated on a process domain when the amount of memory associated with these portions of the machine learning model, in aggregate, is less than the total amount of available addressable memory on the process domain.

In some aspects, instantiating the machine learning model across the plurality of process domains includes mapping outputs of a first subgraph from the plurality of subgraphs to inputs of a second subgraph of the plurality of subgraphs. Generally, the outputs of a first subgraph may be mapped to a defined memory address accessible by multiple process domains. The inputs of the second subgraph may also be mapped to this defined memory address, as the second subgraph may use, at least in part, data generated by the first subgraph in order to perform the operations defined for the second subgraph.

At block 530, the operations 500 proceed with generating an inference based on executing the machine learning model across the plurality of process domains.

In some aspects, executing the machine learning model across the plurality of process domains may include sequentially executing the plurality of subgraphs based on outputs of a first subgraph in the plurality of subgraphs corresponding to inputs of a second subgraph in the plurality of subgraphs. Generally, as discussed above, some subgraphs within the machine learning model may rely on data generated by other subgraphs within the machine learning model. Thus, the subgraphs which relay on data generated by other subgraphs may execute later, and the subgraphs whose outputs are used as inputs downstream may be executed earlier. In some aspects, subgraphs sharing common dependencies may be executed on different process domains simultaneously, or substantially simultaneously. In such a manner, a machine learning model may be executed more efficiently.

In some aspects, the sequential execution of the plurality of subgraphs may be performed as an atomic, or uninterruptable, operation. By doing so, aspects of the present disclosure can minimize, or at least reduce, the likelihood that hardware resources used by a process domain will be reallocated (e.g., by an operating system executing on the processing system) to a different process and incur overhead and latencies from swapping the machine learning model (as well as points, variable names/values, and the like) into and out of the memory associated with the process domain.

At block 540, the operations 500 proceed with taking one or more actions based on the generated inference.

In some aspects, the operations 500 may further proceed with releasing the plurality of process domains to terminate execution of the machine learning model. Generally, releasing the plurality of process domains includes terminating the process domains across the plurality of process domains on which the subgraphs of the plurality of subgraphs are instantiated. After terminating these process domains, various memory maintenance operations can be performed to deallocate memory resources (e.g., at defined addresses) from usage with the machine learning model and make these resources available for use by other applications.

In some aspects, the machine learning model may be a generative artificial intelligence model. The generative artificial intelligence model may be a textual large language model, an image-based or video-based generative model, or the like. The one or more actions may, in such a case include generating a response to an input query using the generative artificial intelligence model. The response may include data in one or more of a textual modality, an audio modality, or a video modality.

In some aspects, the one or more actions may be based on the application for which the machine learning model is deployed (e.g., control of an autonomous vehicle using control signals generated based on inferences generated by the machine learning model, control of a robotic arm based on inferences generated by the machine learning model, etc.). For example, based on detecting objects within a field of travel, one or more control signals may be generated to control the motion of an autonomous vehicle, a robotic arm, or the like, in order to minimize, or at least reduce, the likelihood that the autonomous vehicle, robotic arm, etc. will collide with the detected objects. In another example, based on predicting that an object will travel in a particular direction relative to an autonomous vehicle, robotic arm, or the like, one or more control signals may be generated to cause the autonomous vehicle, robotic arm, etc. to change a direction of motion and/or the speed at which such motion is performed in order to minimize, or at least reduce, the likelihood that the autonomous vehicle, robotic arm, etc. will move in conflict with the object for which future motion is predicted.

In yet another example, based on semantic segmentation of an image into classes of objects that are of interest and classes of objects that can be ignored (e.g., foreground content and background content, or moving content and static content), image data can be compressed using varying compression schemes with varying degrees of compression loss (e.g., such that foreground content or moving content is compressed using lossless or near-lossless compression schemes, while background content or static content is compressed using lossier compression schemes). It should be noted that the foregoing are but examples of additional actions that can be performed based on at least one of the first output and the second output, and other actions may be contemplated based on the environment in which (or the application for which) the machine learning model is deployed.

In some aspects, each respective subgraph of the plurality of subgraphs may be associated with a respective memory space shared within the same application. In doing so, the application may be allowed to execute and share data across multiple process domains.

### Example Processing Systems for Executing Machine Learning Model Operations Across Process Domains

FIG. 6 depicts an example processing system 600 for executing machine learning models across process domains based on a graph for a machine learning model including one or more subgraphs, such as described herein with respect to FIG. 5.

The processing system 600 includes at least one central processing unit (CPU) 602, which in some examples may be a multi-core CPU. Instructions executed at the CPU 602 may be loaded, for example, from a program memory associated with the CPU 602 or may be loaded from a memory partition (e.g., of memory 624).

The processing system 600 also includes additional processing components tailored to specific functions, such as a graphics processing unit (GPU) 604, a digital signal processor (DSP) 606, a neural processing unit (NPU) 608, a multimedia processing unit 610, and a connectivity component 612.

An NPU, such as the NPU 608, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 608, are configured to accelerate the performance of common machine learning tasks, such as image classification, machine translation, object detection, and various other predictive models. In some examples, a plurality of NPUs may be instantiated on a single chip, such as a system on a chip (SoC), while in other examples such NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this new piece through an already trained model to generate a model output (e.g., an inference).

In some implementations, the NPU 608 is a part of one or more of the CPU 602, the GPU 604, and/or the DSP 606. These may be located on a user equipment (UE) in a wireless communication system or another computing device.

In some examples, the connectivity component 612 may include subcomponents, for example, for third generation (3G) connectivity, fourth generation (4G) connectivity (e.g., Long-Term Evolution (LTE)), fifth generation (5G) connectivity (e.g., New Radio (NR)), Wi-Fi connectivity, Bluetooth connectivity, and other wireless data transmission standards. The connectivity component 612 may be further coupled to one or more antennas 614.

The processing system 600 may also include one or more sensor processing units 616 associated with any manner of sensor, one or more image signal processors (ISPs) 618 associated with any manner of image sensor, and/or a navigation processor 620, which may include satellite-based positioning system components (e.g., GPS or GLONASS) as well as inertial positioning system components.

The processing system 600 may also include one or more input and/or output devices 622, such as screens, touch-sensitive surfaces (including touch-sensitive displays), physical buttons, speakers, microphones, and the like.

In some examples, one or more of the processors of the processing system 600 may be based on an ARM or RISC-V instruction set.

The processing system 600 also includes a memory 624, which is representative of one or more static and/or dynamic memories, such as a dynamic random access memory, a flash-based static memory, and the like. In this example, the memory 624 includes computer-executable components, which may be executed by one or more of the aforementioned processors of the processing system 600.

In particular, in this example, the memory 624 includes a graph receiving component 624A, a model instantiating component 624B, an inference generating component 624C, an action taking component 624D, and a machine learning model component 624E. The depicted components, and others not depicted, may be configured to perform various aspects of the methods described herein.

Generally, the processing system 600 and/or components thereof may be configured to perform the methods described herein.

### Example Clauses

Implementation details of various aspects of the present disclosure are set forth in the following numbered clauses:
Clause 1: A processor-implemented method, comprising: receiving a graph for a machine learning model, the graph for the machine learning model including a plurality of subgraphs representing different portions of the machine learning model; instantiating the machine learning model across a plurality of process domains associated with a same application based on the plurality of subgraphs in the graph for the machine learning model; generating an inference based on executing the machine learning model across the plurality of process domains; and taking one or more actions based on the generated inference.
Clause 2: The method of Clause 1, wherein instantiating the machine learning model across the plurality of process domains comprises instantiating a portion of the machine learning model represented by a corresponding subgraph from the plurality of subgraphs based on an amount of memory associated with the portion of the machine learning model and an available amount of memory on a process domain from the plurality of process domains.
Clause 3: The method of Clause 1 or 2, wherein instantiating the machine learning model across the plurality of process domains comprises mapping outputs of a first subgraph from the plurality of subgraphs to inputs of a second subgraph of the plurality of subgraphs.
Clause 4: The method of any of Clauses 1 through 3, wherein each respective subgraph of the plurality of subgraphs is associated with a respective memory space shared within the same application.
Clause 5: The method of any of Clauses 1 through 4, wherein executing the machine learning model across the plurality of process domains comprises sequentially executing the plurality of subgraphs based on outputs of a first subgraph in the plurality of subgraphs corresponding to inputs of a second subgraph in the plurality of subgraphs.
Clause 6: The method of Clause 5, wherein sequentially executing the plurality of subgraphs comprises an atomic operation.
Clause 7: The method of any of Clauses 1 through 6, further comprising releasing the plurality of process domains to terminate execution of the machine learning model.
Clause 8: The method of any of Clauses 1 through 7, wherein the machine learning model comprises a generative artificial intelligence model.
Clause 9: The method of Clause 8, wherein the one or more actions comprise generating a response to an input query using the generative artificial intelligence model.
Clause 10: The method of any of Clauses 1 through 9, wherein the machine learning model comprises a classifier neural network.
Clause 11: The method of Clause 10, wherein the one or more actions comprise generating one or more control signals to control an autonomous vehicle based on a classification of one or more objects in a scene generated by the classifier neural network.
Clause 12: The method of Clause 10 or 11, wherein the one or more actions comprise applying different levels of compression to different portions of an image based on classifications of different objects in the image generated by the classifier neural network.
Clause 13: A processing system comprising: a memory having executable instructions stored thereon; and one or more processors configured to execute the executable instructions in order to cause the processing system to perform the operations of any of Clauses 1 through 12.
Clause 14: A system comprising means for performing the operations of any of Clauses 1 through 12.
Clause 15: A non-transitory computer-readable medium having executable instructions stored thereon which, when executed by one or more processors, cause the one or more processors to perform the operations of any of Clauses 1 through 12.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processor-implemented method, comprising:
receiving a graph for a machine learning model, the graph for the machine learning model including a plurality of subgraphs representing different portions of the machine learning model;
instantiating the machine learning model across a plurality of process domains associated with a same application based on the plurality of subgraphs in the graph for the machine learning model;
generating an inference based on executing the machine learning model across the plurality of process domains; and
taking one or more actions based on the generated inference.

2. The method of claim 1, wherein instantiating the machine learning model across the plurality of process domains comprises instantiating a portion of the machine learning model represented by a corresponding subgraph from the plurality of subgraphs based on an amount of memory associated with the portion of the machine learning model and an available amount of memory on a process domain from the plurality of process domains.

3. The method of claim 1, wherein instantiating the machine learning model across the plurality of process domains comprises mapping outputs of a first subgraph from the plurality of subgraphs to inputs of a second subgraph of the plurality of subgraphs.

4. The method of claim 1, wherein each respective subgraph of the plurality of subgraphs is associated with a respective memory space shared within the same application.

5. The method of claim 1, wherein executing the machine learning model across the plurality of process domains comprises sequentially executing the plurality of subgraphs based on outputs of a first subgraph in the plurality of subgraphs corresponding to inputs of a second subgraph in the plurality of subgraphs.

6. The method of claim 5, wherein sequentially executing the plurality of subgraphs comprises an atomic operation.

7. The method of claim 1, further comprising releasing the plurality of process domains to terminate execution of the machine learning model.

8. The method of claim 1, wherein the machine learning model comprises a generative artificial intelligence model.

9. The method of claim 8, wherein the one or more actions comprise generating a response to an input query using the generative artificial intelligence model.

10. The method of claim 1, wherein the machine learning model comprises a classifier neural network.

11. The method of claim 10, wherein the one or more actions comprise generating one or more control signals to control an autonomous vehicle based on a classification of one or more objects in a scene generated by the classifier neural network.

12. The method of claim 10, wherein the one or more actions comprise applying different levels of compression to different portions of an image based on classifications of different objects in the image generated by the classifier neural network.

13. A processing system, comprising:
a memory having executable instructions stored thereon; and
one or more processors coupled to the memory and configured to execute the executable instructions in order to cause the processing system to:
receive a graph for a machine learning model, the graph for the machine learning model including a plurality of subgraphs representing different portions of the machine learning model;
instantiate the machine learning model across a plurality of process domains associated with a same application based on the plurality of subgraphs in the graph for the machine learning model;
generate an inference based on executing the machine learning model across the plurality of process domains; and
take one or more actions based on the generated inference.

14. The processing system of claim 13, wherein to instantiate the machine learning model across the plurality of process domains, the one or more processors are configured to cause the processing system to instantiate a portion of the machine learning model represented by a corresponding subgraph from the plurality of subgraphs based on an amount of memory associated with the portion of the machine learning model and an available amount of memory on a process domain from the plurality of process domains.

15. The processing system of claim 13, wherein to instantiate the machine learning model across the plurality of process domains, the one or more processors are configured to cause the processing system to map outputs of a first subgraph from the plurality of subgraphs to inputs of a second subgraph of the plurality of subgraphs.

16. The processing system of claim 13, wherein each respective subgraph of the plurality of subgraphs is associated with a respective memory space shared within the same application.

17. The processing system of claim 13, wherein to execute the machine learning model across the plurality of process domains, the one or more processors are configured to cause the processing system to sequentially execute the plurality of subgraphs based on outputs of a first subgraph in the plurality of subgraphs corresponding to inputs of a second subgraph in the plurality of subgraphs.

18. The processing system of claim 17, wherein sequentially executing the plurality of subgraphs comprises an atomic operation.

19. The processing system of claim 13, wherein the one or more processors are further configured to cause the processing system to release the plurality of process domains to terminate execution of the machine learning model.

20. The processing system of claim 13, wherein the machine learning model comprises a generative artificial intelligence model.

21. The processing system of claim 20, wherein the one or more actions comprise generating a response to an input query using the generative artificial intelligence model.

22. The processing system of claim 13, wherein the machine learning model comprises a classifier neural network.

23. The processing system of claim 22, wherein the one or more actions comprise generating one or more control signals to control an autonomous vehicle based on a classification of one or more objects in a scene generated by the classifier neural network.

24. The processing system of claim 22, wherein the one or more actions comprise applying different levels of compression to different portions of an image based on classifications of different objects in the image generated by the classifier neural network.

25. A processing system, comprising:
means for receiving a graph for a machine learning model, the graph for the machine learning model including a plurality of subgraphs representing different portions of the machine learning model;
means for instantiating the machine learning model across a plurality of process domains associated with a same application based on the plurality of subgraphs in the graph for the machine learning model;
means for generating an inference based on executing the machine learning model across the plurality of process domains; and
means for taking one or more actions based on the generated inference.

26. The processing system of claim 25, wherein the means for instantiating the machine learning model across the plurality of process domains comprises means for instantiating a portion of the machine learning model represented by a corresponding subgraph from the plurality of subgraphs based on an amount of memory associated with the portion of the machine learning model and an available amount of memory on a process domain from the plurality of process domains.

27. The processing system of claim 25, wherein the means for instantiating the machine learning model across the plurality of process domains comprises means for mapping outputs of a first subgraph from the plurality of subgraphs to inputs of a second subgraph of the plurality of subgraphs.

28. The processing system of claim 25, wherein the means for executing the machine learning model across the plurality of process domains comprises means for sequentially executing the plurality of subgraphs based on outputs of a first subgraph in the plurality of subgraphs corresponding to inputs of a second subgraph in the plurality of subgraphs.

29. The processing system of claim 25, further comprising means for releasing the plurality of process domains to terminate execution of the machine learning model.

30. A non-transitory computer-readable medium having executable instructions stored thereon which, when executed by one or more processors, perform an operation comprising:
receiving a graph for a machine learning model, the graph for the machine learning model including a plurality of subgraphs representing different portions of the machine learning model;
instantiating the machine learning model across a plurality of process domains associated with a same application based on the plurality of subgraphs in the graph for the machine learning model;
generating an inference based on executing the machine learning model across the plurality of process domains; and
taking one or more actions based on the generated inference.
